(19) United States
(12) Patent Application Publication
(10) Pub. No.: US 2010/0169405 A1
(43) Pub. Date: Jul. 1, 2010

(54) Method and Device for Transmission and Update of Continuous Data Set

(76) Inventor: Yongmin Zhang, Guangdong (CN)

Correspondence Address: BYIP, LTD., P.O. BOX 1484, GENERAL POST OFFICE, HONG KONG, HK

(21) Appl. No.: 12/063,030

(22) PCT Filed: Jul. 31, 2006
(86) PCT No.: PCT/CN06/01903

§ 371 Date: Feb. 6, 2008

(30) Foreign Application Priority Data
Aug. 9, 2005 (CN) 200510021480.0

(51) Int. Cl. G06F 15/16

(52) U.S. Cl. 709/203

(57) ABSTRACT

A transmission and updating method and the apparatus thereof for consecutive changing data. The method comprising the steps: the server extracts the data set from the consecutive changing data at the predetermined time interval consecutively (101); the server compares the whole set of the latest data set with the whole set of the prior one in the form of symbol to obtain the changing string; vary the changing string to the changing set (102); transmit the changing set to one or more clients (103) so that the clients can update the data set to the latest data set according to the current data set (104). The method of the present invention divides the data set into several symbols, as the symbol is flexible, an item can be divided into multiple symbols, and the data sets are compared with the symbol as a unit to diminish the compared unit, so the byte length of the obtained changing string is reduced, such that the transmission quantity is reduced greatly, the transmission speed is increased and the requirement for bandwidth is reduced.

### FIELD OF THE INVENTION

The present invention relates to a method and a device for transmission and update of continuous data sets, and particularly to a method and a device by which a server computer (hereinafter referred to as a “server”) transfers a continuous data set to one or more client computers (hereinafter referred to as a “client”) via network and the server responds to an update request of the client.

### BACKGROUND OF THE INVENTION

When the server has a continuous data set to be transferred to the client, the server will continuously and circularly extract the data in a short time interval, and transfer to the client. This transmission is not restricted by physical constraints of the transmission system, but affected by the bandwidth, and therefore the data are required to be compressed before being transferred to the client.

For example, for quotation transmission of the securities and futures industry or the foreign exchange, a price change has to be transferred to the client in time, the quotation data have a comparatively large volume and are affected by the bandwidth, and therefore the data are required to be processed before being transferred to the client.

For the multicast as another example, the content is transferred to a group of clients along a transmission path, which requires a client list (transmission of the control data); the list is dynamically changed, and we need to maintain it, making the source in accordance with the client data in the client. It is required to transfer as few as possible bytes, upon request of the transmission speed. Therefore, the data are also required to be processed before being transferred to the client.

Compressing the data in a traditional way (e.g. the dictionary compression) will take a longer time, and be difficult to satisfy the real-time transmission requirement. It is commonly adopted to mark the changed part and generate a variation set Cn before transferring to the client. For example, it is marked as [i+content of Item i] when Item i changes, where “i” stands for Item i; then [i+content of Item i] will be transferred to the client, which updates only Item i according to the received content. The changed part is obtained by comparison of the current data set Pn with the previous changed data set Pn−1. During the comparison, each item (ITEM) of the data set Pn is compared with the corresponding item of the data set Pn−1, and the changed item will be select to form a variation string, that is, the variation string includes all the bytes of the changed items. The transmission method has the following weaknesses: 1) There are many bytes without change in the changed item, and usually just some individual bytes are changed each time. If the entire item is included in the variation string, it will sure increase length of the variation set, enhance the network transmission volume, increase the requirement for the bandwidth, and lower the transmission speed. 2) When the items are inconsistent in length, it will become difficult to compare by the items, and the length information is further needed. 3) In the transmission where only the changed part is transferred, there will be a large amount of the additional information for marking, which therefore, will also increase length of the entire data set transferred, enhance the requirement for the bandwidth, and lower the transmission speed.

In the traditional data transmission, the client is always required to transfer back an acknowledgement of receipt whenever the server transfers one variation set to the client, which virtually increases the network transmission volume. It is also difficult to provide one server that provides service for multiple clients.

### BRIEF SUMMARY OF THE INVENTION

A main purpose of the present invention is to provide a method and a device for transmission and update of the continuous data sets, so as to resolve the problems with the prior art, reduce the transmission volume, increase the transmission speed, and lower the requirement for the bandwidth.

A second purpose of the present invention is to provide a method for transmission and update of the continuous data sets, so as to resolve the problems with the prior art, remove the requirement for the client transferring back the acknowledgement of receipt after receiving the variation set, and reduce the network transmission volume.

A further purpose of the present invention is to provide a method for transmission and update of the continuous data sets, so as to resolve the problems with the prior art, and reduce bytes of the additional information used for marking.

In order to realize the above-mentioned purposes, the present invention provides a method for transmission and update of the continuous data sets, the method comprising:

A1. extracting the data set according to a set time interval for the continuous data by a server continuously;

B1. comparing an integral set of the latest data set with that of its previous data set by symbols, and obtaining a variation string;

C1. transforming and compressing the variation string before the variation set is obtained; and

D1. transferring the change set to one or more clients, so that the client updates the data set to the latest one according to its current data set.

In the above-mentioned comparison of Step B1, the comparison of this time can be ignored if the latest data set has no change compared with its previous one. A null variation string may also be obtained, and the client is specifically notified that the data set has no change this time.

A compression function is usually selected for the above-mentioned transformation of Step C1.

The above-mentioned client of Step D1 permits using one or more of the clients, and the variation set compressed once can be transferred to multiple clients. Transmission of the variation set is not limited to a specific method. It can be transferred in a C/S way, a distribution-tree way, or a P2 P way, etc.

A further improvement of the present invention is as below: Each of the variation sets includes a starting mark (used for identifying the variation set head), a new data set mark, a mark reflecting the old data set, at least one variation string element (can be a null string), and an offset value of the ending position of this variation string element relative to that of the previous variation string element; the variation string element includes a variation string element head and the variation string; and the variation string element head includes a variation string head mark and the variation string length.

A still further improvement of the present invention is as below: The server marks the extracted data set according to the extraction sequence, and identifies the data set of different period or state with a data set mark; and the server transforms the variation string before making a corresponding mark to obtain the variation set, that is, different variation sets use different variation set marks. The mark can be either a series of continuous data, or a series of data not continuous but having a certain order, and is used for distinguishing between different data sets.

The variation set the server transfers to the client includes the corresponding mark.

The server stores the latest several marked data sets. The client updates the data set to the latest one according to the received variation set and its current data set, and marks the latest data set with the same mark with the latest data set of the server.

wherein said updating the data set comprises:

A2. judging, when the client receives the latest variation set, whether the client has the data set to which the variation set is according, and execute Step B2 if it does, or execute Step C2 if it does not;

B2. updating the data set to the latest one and marking it according to the data set to which the variation set is according and the latest variation set;

C2. requesting the server to transfer the corresponding variation set according to the mark of the current data set in the client; and

D2. updating the data set, after the client receiving the corresponding variation set, to which the variation set in the client is according to the latest one and makes the mark.

If the variation string is obtained after comparison of the latest data set with a certain previous one, this certain data set is the one to which this variation set is according. The data set to which this variation set is according may be either the current data set in the client, or the previous data set of the client.

The corresponding variation set received by the client in the above-mentioned Step D2 can be either the latest complete data set, or a transform of the latest data set, whose transformation is compression not limited to format, or the corresponding transformed data (variation sets) capable for being restored according to the existing data of the client.

The latest data set is stored which is updated in the above-mentioned Step B2 or D2, and used as the current data set in the next update. That is, the client has an old data set (being a null set at first), depending to which the variation set is transformed and restored to the latest data set, which is also the foundation of data compression of the present invention.

after receiving a request from the client for transferring the corresponding variation set, the method further comprising:

A3. checking whether the server has the corresponding variation set the client requests, and execute Step E3 if it does, or execute Step B3 if it does not;

B3. searching for the corresponding data set stored in the server that has the same mark with the current data set in the client;

C3. comparing the latest data set with the corresponding data set in Step B3 by the symbols, and obtains the variation string;

D3. transforming and marking the variation string before obtaining the corresponding variation set; and

E3. transferring the corresponding variation set to the client, so that the client updates the data set to the latest one according to its current data set and makes a mark.

When the corresponding data set is not found in the server in Step B3 that has the same mark with the current data set in the client, this corresponding data set will be set as a null set.

Another technical solution of the present invention for decreasing the network transmission volume comprising:

A4. extracting the data set according to a set interval for the continuous data by a server continuously, and marking the data set according to the extraction sequence;

B4. comparing the integral set of the latest data set with that of its previous data set, and obtains the variation string;

C4. transforming, compressing and correspondingly marking the variation string before the variation set is obtained; and

D4. transferring the variation set to one or more of the clients, so that the client updates the data set to the latest one according to its current data set, and the latest data set is marked with the same mark with the same data set of the server.

The extracted data set in Step A4 is marked according to the extraction sequence, such that it is convenient to know the real-time property of the data set of the client and to update the data set.

Preferably, the comparison in Step B4 of the integral set of the latest data set with that of its previous data set is performed by the symbols.

In order to realize the above-mentioned purposes, the present invention further provides a device for transmission and update of the continuous data sets, the device comprising:

data set generation unit adapted to generate the data set from the continuous data according to a set time interval;

data set compare unit adapted to compare the latest data set Pn with its previous or certain data set Pk by the symbols according to the integral set, and obtains the variation string;

variation set generation unit adapted to transform and mark the variation string before forming the variation set Cnk; and

variation set sending unit adapted to send the continuous or noncontinuous variation set Cnk to the client.

Said device further comprising data set storage unit adapted to store the data sets and a variation set storage unit adapted to store the variation sets.

In order to realize the above-mentioned purposes, the present invention further provides a device for transmission and update of the continuous data sets, said device comprising a server and a client;

said server comprising:

data set generation unit adapted to generate the data set from the continuous data according to a set time interval;

data set compare unit adapted to compare the latest data set Pn with its previous or certain data set Pk by the symbols according to the integral set, and obtains the variation string;

variation set generation unit adapted to transform and mark the variation string before forming the variation set Cnk; and

variation set sending unit adapted to send the continuous or noncontinuous variation set Cnk to the client;

said client comprising:

variation set receiving unit adapted to receive the variation set Cnk;

variation set decompression unit adapted to decompress the variation set Cnk; and

data set update unit adapted to update the current data set Pk to the same latest data set Pn with the server.

A further improvement of the present invention is, said client further comprising variation set transmission request unit, said data set update unit of the client being further used for checking the mark of the current data set in the data set storage unit of the client; if the current data set is not used as the data set Pk that is the update basis of the received variation set Cnk, the variation set transmission request unit is controlled to request the server to send the variation set with the current data set as the update basis.

In order to realize the above-mentioned purposes, the present invention further provides a computer-readable medium with a computer-executable program, wherein the program realizes the following functions through execution of the server computer:

A7. extracting the data set according to a set time interval for the continuous data continuously;

B7. comparing the integral set of the latest data set with that of its previous data set by the symbols, and obtaining the variation string;

C7. transforming and compressing the variation string before the variation set is obtained; and

D7. transferring the variation set to one or more of the clients, so that the client updates the data set to the latest one according to its current data set.

The program further realizes the following functions through execution of the computer:

E7. checking whether in the server is stored the corresponding variation set requested by the client after receiving the request from the client for transmission of the corresponding variation set, and execute Step I7 if it is, or execute Step F7 if it is not;

F7. searching for the corresponding data set stored in the server that has the same mark with the current data set in the client;

G7. comparing the latest data set with the corresponding data set in Step B3 by the symbols, and obtain the variation string;

H7. transforming and marking the variation string before obtaining the corresponding variation set; and

I7. transferring the corresponding variation set to the client, so that the client updates the data set to the latest one according to its current data set and makes a mark.

In order to realize the above-mentioned purposes, the present invention further provides a computer-readable medium with a computer-executable program, wherein the program further realizes the following functions through execution of the client computer:

A8. judging, when the client receives the latest variation set, whether the client has the data set to which the variation set is according, and execute Step B8 if it does, or execute Step C8 if it does not;

B8. updating the data set to the latest one and marking it according to the data set to which the variation set is according and the latest variation set;

C8. requesting the server to transfer the corresponding variation set according to the mark of the current data set in the client; and

D8. updating the data set in the client to the latest one and makes the mark after receiving the corresponding variation set by the client.

The present invention has the following beneficial effects: 1) There is usually a small change in a certain duration for many dynamically changed data sets. The data set is divided into some symbols under a transmission mode where only the changed part is transferred. Because of high randomness of the symbol, its length can be one or two bytes, etc. An item may be divided into many symbols. The data sets are mutually compared taking the symbol as a unit, thus decreasing the compare unit. Therefore, the bytes of the obtained variation string are decreased in length, thus substantially reducing the transmission volume, increasing the transmission speed, and lowering the requirement for the bandwidth. 2) The variation string in the outputted variation set is marked by a relative-position mark method, and an offset value of the variation string relative to the ending position of the previous variation string element is used to describe position of the variation string, thus reducing bytes of the additional marks used for showing the position, further reducing the transmission volume, and increasing the transmission speed. 3) Right upon extraction of the data set, the server will mark the data set according to the extraction sequence, and add the corresponding mark to the variation set. Meanwhile the client receives and updates the variation set before adding the same mark to the data set with the latest data in the server, such that upon receipt of the variation set the client can judge whether the variation set is desired according to the mark of the data set, and will update if it is, or request the server to transmit the desired variation set if it is not. It is not necessary to send back an acknowledgement of receipt each time one variation set is received, thus reducing the network transmission volume and easing the network congestion. 4) Without the need to consider the data format of the data set, the processing method is simple and the calculation amount low, applicable for occasions where a very high real-time property is required. 5) A one-time compression result can be used by several of the clients at the same time, thus lowering the calculation amount, increasing the response speed of the server, and meanwhile being able to conveniently transfer in the P2 P way.

Characteristics and advantages of the present invention will be described in detail with reference to embodiments and attached drawings.

### BRIEF DESCRIPTION OF THE DRAWINGS

FIG. 1 is a schematic drawing of a structure in an embodiment of the present invention.

FIG. 2 is a comparison between the mark of the changed part of the prior art and that of the changed part of the present invention.

FIG. 3 is a flow chart of an embodiment of the present invention where the server compares the latest data with its previous one and generates and transfers the variation set.

FIG. 4 is a flow chart of an embodiment of the present invention where the server compares the latest data with its certain previous one and generates and transfers the variation set.

FIG. 5 is a flow chart of an embodiment of the present invention where the client receives the variation set.

### DETAILED DESCRIPTION OF THE INVENTION

### Embodiment 1

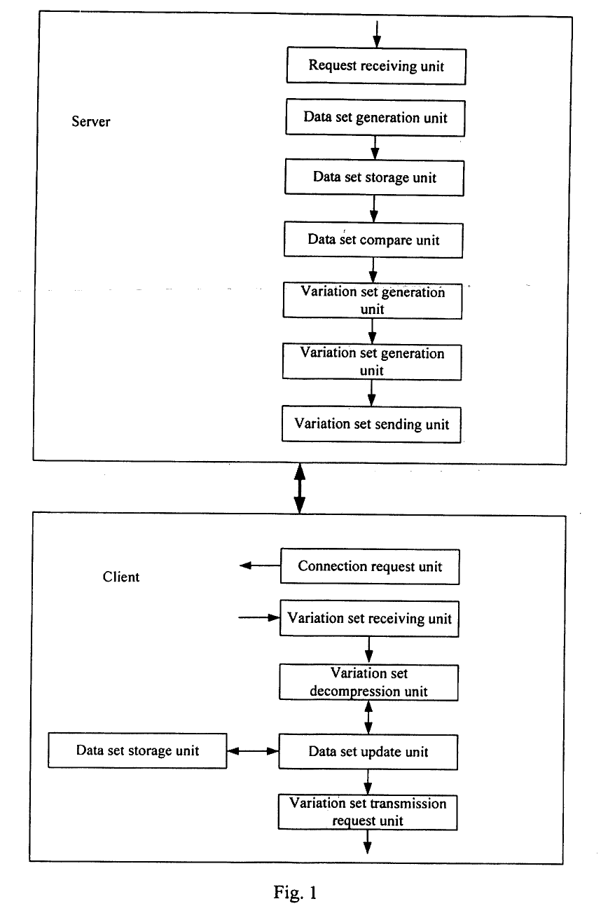

As shown in FIG. 1, the server includes the data set generation unit, the data set storage unit, the data set compare unit, the variation set generation unit, the variation set storage unit, the variation set sending unit, and the request receiving unit. The client includes the connection request unit, the variation set receiving unit, the variation set decompression unit, the data set storage unit, the data set update unit, and the variation set transmission request unit.

The data set generation unit of the server generates the data set from the continuous data according to a set time interval, and the data set storage unit stores these data sets. The data set compare unit compares the latest data set Pn with its previous one Pn−1 by the symbols according to the integral set, and obtains the variation string. The variation string, after being transformed and marked by the variation set generation unit, forms the variation set Cn, which is stored in the variation set storage unit. Moreover, the request receiving unit of the server receives requests from the client; the data set compare unit compares the latest data set Pn with its certain previous one Pk by the symbols according to the integral set, and obtains the variation string; and the variation string, after being transformed, compressed and marked by the variation set generation unit, forms the variation set Cnk, which is also stored in the variation set storage unit. The variation set sending unit sends to the client the continuous variation set Cn or the variation set Cnk.

One of the servers supports several of the clients. The connection request unit of the client requests the server for connection. If it is an initial connection, the data set update unit of the client will check the mark of the current data set Pk in the data set storage unit of the client, where Pk can be a null set (P0), and request the variation set transmission unit to request the server to send the variation set Cnk; the server will transfer the variation set Cnk to the client after authentication; the variation set receiving unit of the client receives the variation set Cnk, which is decompressed via the variation set decompression unit; and the data set update unit updates the current data set Pk to the same latest data set Pn with the server. If it is not an initial connection, the variation set receiving unit of the client will directly receive the continuous variation set Cn transferred by the variation set sending unit of the server. Through decompression via the variation set decompression unit, the data set update unit updates the current data set Pn−1 to the same latest data set Pn with the server. If the data set update unit finds that the current data set in the data set storage unit is not the data set Pn−1, the current data set cannot be used as the update basis of the variation set Cn, and the data set update unit will control the variation set transmission request unit to request the server to send the variation set that can use the current data set as the update basis.

As for the server, the comparison of the latest data set Pn with its certain previous data set Pk (k can be either equal to n−1 or smaller than n−1) according to the integral set is performed by the symbols. The symbol is flexible to be divided, and not necessary to be limited to an item. One or two bytes can be defined as a symbol, and an item usually has a few or even more than ten bytes, and therefore an item can be divided into several symbols. This comparison method reduces the compare unit. For the transmission method of transferring only the changed part, the smaller the compare unit, the fewer the bytes of the obtained variation string after the comparison. However, only with the variation string can the client not update the data set, and it is further necessary for the client to be told about the position of this variation string. Therefore, each of the variation sets in this embodiment includes a starting mark, a new data set mark, an old data set mark, at least one variation string element, and an offset value of the relative position of this variation string element, the variation string element including a variation string element head and the variation string, the variation string element head including a variation string head mark and the variation string length. Transformation method and effect of the variation set of this embodiment are as below:

First, improve the compare object, and compare by the elements (records) instead of the “symbols”. The “symbol” refers to byte, half word, word, double word, or any other binary number selected and improved in advance. For easy comprehension, here assume that the data are formed by a byte, which can be one or two bytes.

It is assumed that w is corresponding to the distance between start of the data set and position of here. The new data set is compared with the old one according to the sequence from start to end. With extraction of the changed part, the new data set can be decomposed as below:

<changed part 1 ><changed part 2> . . . <changed part i>

The changed part is marked as below after being improved:

Marked as [w+variation string]

[w+variation string] is transferred to the client

The client updates the string starting from the position w.

Then, for identifying the variation string, add the length mark of the variation string, which is as below:

[w1+length+variation string]

Or improve the mark as below:
[variation string head mark+w1+length+string]

Further, improve the mark as below:
[variation string head h1+string]

The meaning of the above-mentioned mark is as below: Compare the new data set with the old one, extract the changed part, and record as “the variation string head h1+the string”, the variation string head h1 including the variation string head mark, the starting position w1 in correspondence with the data set head, and length of the string.

The starting position of most of the data sets in correspondence with the data set head is represented by a 4-byte figure. Therefore, it needs to be improved, and the starting position in correspondence with the data set head is changed as the starting position in correspondence with the ending position of the previous variation string. The variable length coding can be used for this relative position, along with the head mark that is represented with a figure of variable bytes (1-4 bytes), thus attaining the compression purpose.

The variable length coding is also used for length of the string, along with the string head mark that is represented with a figure of variable bytes (1-4 bytes), permitting further compression.

Here, the relative position is corresponding to the offset position, with the relative position being called an Offset.

Further, improve the mark as below:
[offset w2+variation string head h2+string]

Represent the above-mentioned mark separately:
[offset w2][variation string head h2+string]

The variation string head h2 includes the variation set head mark and length of the string, without the starting position.

On the other hand, the new data set can be decomposed as below:

<unchanged part 1><changed part 1><unchanged part 2><changed part 2> . . . <unchanged part i><changed part i>

which is changed into:

[non-variation string head 1+non-variation string 1][variation string head 1+variation string 1][non-variation string head 2+non-variation string 2][variation string head 2+variation string 2] . . . [non-variation string head i+non-variation string i][variation string head i+variation string i]

With the old data set as a contrast, the non-variation string is not needed to be recorded. Therefore, it is changed as below:

[non-variation string head 1][variation string head 1+variation string 1][non-variation string head 2][variation string head 2+variation string 2] . . . [non-variation string head i][variation string head i+variation string i]

For the data set with a real-time change but a low changing rate, an efficient compression can be obtained.

Here, the non-variation string head is also corresponding to an offset position. It is finally simplified as below:

[offset 1] [variation string head 1+variation string 1][offset 2] [variation string head 2+variation string 2] . . . [offset i][variation string head i+variation string i]

Here:

Offset: Including an offset head mark and offset length of the variable length coding.

Variation string head: Including a variation string head mark and length of the variation string of the variable length coding.

The above-mentioned simplified marking method is referred to as a relative-position marking method. The following effects can be obtained according to the relative-position marking method:

1. There is usually a small change in a certain duration for many dynamically changed data sets. In the transmission where only the changed part is transferred, the transmission volume can be substantially reduced.

2. The additional information used for marking can be effectively reduced in volume. The following items are included after the additional transmission information is added: A starting mark, a reference data set mark, the check sum of the data set Pn, an ending mark, etc. The new data set changes from the old one and the variation set is obtained:

[starting mark][new data set mark][old data set mark][offset 1][variation string head 1+variation string 1][offset 2][variation string head 2+variation string 2] . . . [offset i][variation string head i+variation string i][check sum][ending mark]

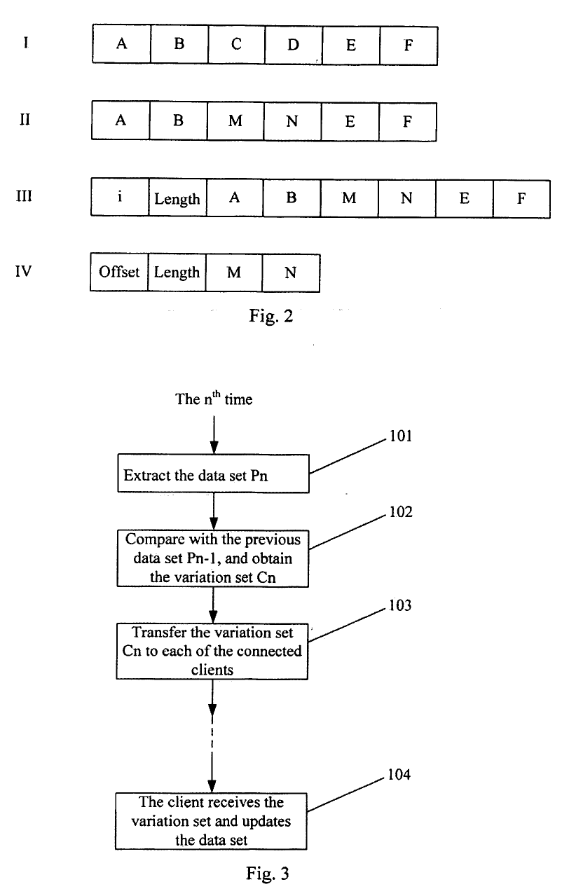

As shown in FIG. 2, I is the data set Pn−1, and II the data set Pn. IV is composed of the variation sets in the embodiment. For example, the two bytes in Item i are changed from “CD” to “MN”, and the total length of this item is 6 bytes. III is composed of the variation sets in the prior art, and from comparison of the latest data set Pn with its previous data set Pn−1 by the items. 4 bytes are needed for the position mark (i.e. the mark of Item i), 2-4 bytes for the length of the variation string, 6 bytes for the variation string, with 12-14 bytes being needed in total. IV is composed of the variation sets in the embodiment. 1-4 bytes are needed for offset after compression of the variable length variable coding, with one byte being usually needed; 1-4 bytes are needed for the length of the variation string, with one byte being usually needed; 2 bytes are needed for the variation string; and therefore 4-10 bytes are needed in total. It is obvious that because of comparison by the symbols in this embodiment, the variation string has fewer bytes, either does the compressed variation set, thus reducing the transmission volume. Generally, an item will include several ten bytes, even up to 100 bytes, of which usually only a few bytes change. The present invention will have a more remarkable effect for such an occasion.

It should be understood that, the different transforms obtained from the changes set based on the inventive concept of the present invention are also fall within the extent of protection of the present invention.

The new data set can be restored from combination of the variation set and the old data set.

FIG. 3 shows the process by which the server compares the latest data set with its previous one as well as generates and transfers the variation set, which includes the following steps:

In Step 101, the server continuously presents and marks the data sets according to a certain time interval, with the marks being P0, P1, . . . , Pn. P0 is a special case, meaning a null data set, while Pn is the latest data set. Also, (only) the latest several presented control data sets. Pi−1, . . . , Pn, are stored in the data set storage unit. Then Step 102 is executed.

In Step 102, the data set compare unit in the server compares the latest data set Pn (n>0) with the previous one Pn−1 according to the integral set from start to end of the data set by the symbols, the variation set generation unit compresses the different parts into the variation set Cn by the relative-position marking method, and the variation set storage unit stores the latest several compressed variation sets, Ci, . . . , Cn. Then Step 103 is executed.

In Step 103, the variation set sending unit of the server transfers the latest variation set Cn to each of the connected clients.

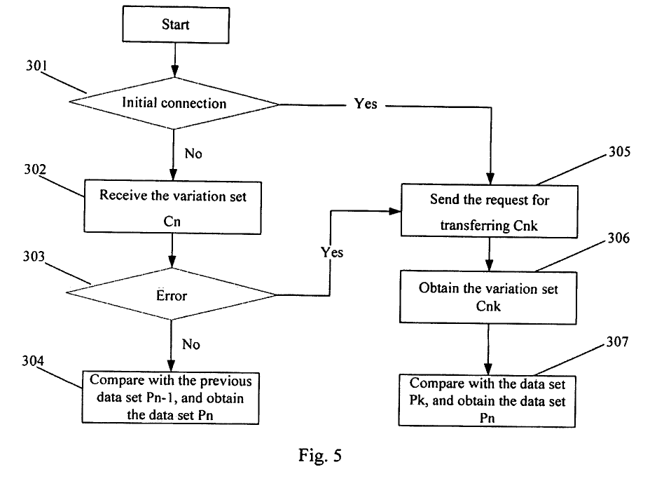

In Step 104, the client receives the variation set transferred over via network and updates the data set. The specific update process is as shown in FIG. 5.

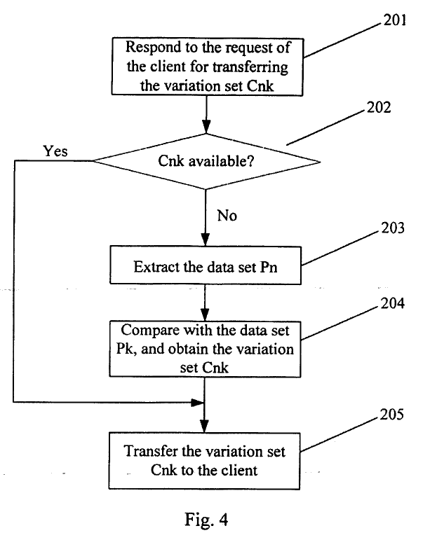

In the above-mentioned embodiment, FIG. 4 shows the process by which the server compares the latest data set with its certain previous one as well as generates and transfers the variation set, which includes the following steps:

In Step 201, the server responds to the client and the request for transmission of the variation set Cnk. Then Step 202 is executed.

In Step 202, the server checks whether the variation set Cnk is in the variation set storage unit. Step 205 will be executed if it is, or Step 203 will be executed if it is not.

In Step 203, the server presents the latest data set Pn. Then Step 204 is executed.

In Step 204, the data set compare unit in the server compares the data set Pn (n>0) with the certain one Pk according to the integral set. Set k as 0 when k<i−1 (that is, the server does not have this data set). The different part is compressed into the variation set Cnk by the relative-position marking method. The compression between the data set Pn and the data set P0 is a special case, i.e. transmission without compression, and other methods can also be selected to compress and transfer. The variation set storage unit stores the variation set Cnk. Then Step 205 is executed.

In Step 205, the variation set sending unit of the server transfers the variation set Cnk to the client that makes the request.

FIG. 5 shows the process by which the client receives the variation set, which includes the following steps:

In Step 301, the client judges whether the connection it requests is the initial one. Step 305 will be executed if it is, or Step 302 will be executed if it is not.

In Step 302, the variation set receiving unit of the client receives the variation set Cnk. Then Step 303 is executed.

In Step 303, the variation set control unit, according to the old data set mark in the received variation set Cn, judges whether the current data set in the data set storage unit of the client is the data set Pn−1. Step 304 will be executed if it is, or treat it as an error and Step 305 will be executed if it is not.

In Step 304, the data set update unit compares the received variation set Cn with the previous one Pn−1, generates Pn according to the relative-position marking method, and marks the updated data set according to the new data set mark in the variation set Cn, thus making the latest data set in the client have the same mark with that in the server.

In Step 305, the client searches for the current data set Pk (probably P0, or one left over from the last connection) and, according to the mark of the current data set Pk, requests the variation set transmission unit to request the server to transfer the variation set Cnk. Then Step 306 is executed.

In Step 306, the variation set receiving unit of the client receives the variation set Cnk, and determines whether the variation set Cnk is right according to the old data set mark in the variation set Cnk. Step 307 is executed if it is.

In Step 307, the data set update unit compares the received variation set Cnk with the data set Pk, and generates Pn according to the relative-position marking method.

### Embodiment 2

What is different from Embodiment 1 is that, in Step 102 of Embodiment 1, the comparison of the latest data set Pn with the previous data set Pn−1 can be performed not by the symbols, but by other methods, as well as can be performed not according to the relative-position marking method, but according to other position marking methods.

The above-mentioned modules or processes can be programmed into a program, which can be installed in a computer, including the server computer.

The program programmed with the above-mentioned modules or processes can be stored in an exterior readable storage medium, which can be a floppy disk, a CD-ROM, a hard disk, a tape recording medium, a semiconductor storage of IC card, or other optical recording media (e.g. DVD or PD) or magnetic recording media. A server system providing network connection can also be used as a readable medium for recording the program. Therein the server program and the client program can also be stored separately in the readable storage medium.

1. A method for transmission and update of continuous data sets, the method comprising:
A1. extracting the data set according to a set time interval for the continuous data by a server continuously;
B1. comparing an integral set of the latest data set with that of its previous data set by symbols, and obtaining a variation string;
C1. transforming and compressing the variation string before the variation set is obtained; and
D1. transferring the change set to one or more clients, so that the client updates the data set to the latest one according to its current data set.

2. The method for transmission and update of the continuous data sets according to claim 1, further comprising:
marking the extracted data set according to the extraction sequence, and transforming the variation string before making a corresponding mark to obtain the variation set.

3. The method for transmission and update of the continuous data sets according to claim 2, further comprising:
storing the latest several marked data sets by the server; updating the data set to the latest one according to the received variation set and its current data set, and marking the latest data set with the same mark with the latest data set of the server by the client.

4. The method for transmission and update of the continuous data sets according to claim 3, wherein said updating the data set comprises:
A2. judging, when the client receives the latest variation set, whether the client has the data set to which the variation set is according, and execute Step B2 if it does, or execute Step C2 if it does not;
B2. updating the data set to the latest one and marking it according to the data set to which the variation set is according and the latest variation set;
C2. requesting the server to transfer the corresponding variation set according to the mark of the current data set in the client; and
D2. updating the data set, after the client receiving the corresponding variation set, to which the variation set in the client is according to the latest one and makes the mark.

5. The method for transmission and update of the continuous data sets according to claim 4, after receiving a request from the client for transferring the corresponding variation set, the method further comprising:
A3. checking whether the server has the corresponding variation set the client requests, and execute E3 if it does, or execute Step B3 if it does not;
B3. searching for the corresponding data set stored in the server that has the same mark with the current data set in the client;
C3. comparing the latest data set with the corresponding data set in Step B3 by the symbols, and obtains the variation string;
D3. transforming and marking the variation string before obtaining the corresponding variation set; and
E3. transferring the corresponding variation set to the client, so that the client updates the data set to the latest one according to its current data set and makes a mark.

6. The method for transmission and update of the continuous data sets according to claim 5, wherein when the corresponding data set is not found in the server in Step B3 that has the same mark with the current data set in the client, it will be set as a null set.

7. The method for transmission and update of the continuous data sets according to claim 1, wherein the symbol in Step B1 is one or two bytes in length.

8. The method for transmission and update of the continuous data sets according to claim 1, wherein each of said variation sets includes a starting mark, a new data set mark, an old data set mark, at least one variation string element, and an offset value of this variation string element relative to the ending position of the previous, variation string element, and said variation string element includes a variation string element head and the variation string, the change string element head including a change string head mark and change string length.

9. A method for transmission and update of continuous data sets, the method comprising:
A4. extracting the data set according to a set interval for the continuous data by a server continuously, and marking the data set according to the extraction sequence;
B4. comparing the integral set of the latest data set with that of its previous data set, and obtains the variation string;
C4. transforming, compressing and correspondingly marking the variation string before the variation set is obtained; and
D4. transferring the variation set to one or more of the clients, so that the client updates the data set to the latest one according to its current data set, and the latest data set is marked with the same mark with the same data set of the server.

10. The method for transmission and update of the continuous data sets according to claim 9, wherein comparing the integral set of the latest data set with that of its previous data set in Step B4 is performed by the symbols.

11. The method for transmission and update of the continuous data sets according to claim 9, wherein said updating the data set comprises:
A5. judging, when the client receives the latest variation set, whether the client has the data set to which the variation set is according, and execute Step B5 if it does, or execute Step C5 if it does not;
B5. updating the data set to the latest one and marking it according to the data set to which the variation set is according and the latest variation set;
C5. requesting the server to transfer the corresponding variation set according to the mark of the current data set in the client; and
D5. updating the data set, after the client receiving the corresponding variation set, to which the variation set in the client is according to the latest one and makes the mark;
After receiving a request from the client for transferring the corresponding variation set, the method comprising:
A6. checking whether the server has the corresponding variation set the client requests, and execute Step E6 if it does, or execute Step B6 if it does not;
B6. searching for the corresponding data set stored in the server that has the same mark with the current data set in the client;
C6. comparing the latest data set with the corresponding data set in Step B6 by the symbols, and obtains the variation string;
D6. transforming and marking the variation string before obtaining the corresponding variation set; and
E6. transferring the corresponding variation set to the client, so that the client updates the data set to the latest one according to its current data set and makes a mark.

12. A device for transmission and update of the continuous data sets, the device comprising:
data set generation unit adapted to generate the data set from the continuous data according to a set time interval;
data set compare unit adapted to compare the latest data set Pn with its previous or certain data set Pk by the symbols according to the integral set, and obtains the variation string;
variation set generation unit adapted to transform and mark the variation string before forming the variation set Cnk; and
variation set sending unit adapted to send the continuous or noncontinuous variation set Cnk to the client.

13. The device for transmission and update of the continuous data sets according to claim 12, further comprising data set storage unit adapted to store the data sets and a variation set storage unit adapted to store the variation sets.

14. A device for transmission and update of the continuous data sets, said device comprising a server and a client;
said server comprising:
data set generation unit adapted to generate the data set from the continuous data according to a set time interval;
data set compare unit adapted to compare the latest data set Pn with its previous or certain data set Pk by the symbols according to the integral set, and obtains the variation string;
variation set generation unit adapted to transform and mark the variation string before forming the variation set Cnk; and
variation set sending unit adapted to send the continuous or noncontinuous variation set Cnk to the client;
said client comprising:
variation set receiving unit adapted to receive the variation set Cnk;
variation set decompression unit adapted to decompress the variation set Cnk; and
data set update unit adapted to update the current data set Pk to the same latest data set Pn with the server.

15. The device for transmission and update of the continuous data sets according to claim 14, said client further comprising variation set transmission request unit, said data set update unit of the client being further used for checking the mark of the current data set in the data set storage unit of the client;
if the current data set is not used as the data set Pk that is the update basis of the received variation set Cnk, the variation set transmission request unit is controlled to request the server to send the variation set with the current data set as the update basis.

16. A computer-readable medium with a computer-executable program, wherein the program realizes the following functions through execution of the server computer:
A7. extracting the data set according to a set time interval for the continuous data continuously;
B7. comparing the integral set of the latest data set with that of its previous data set by the symbols, and obtaining the variation string;
C7. transforming and compressing the variation string before the variation set is obtained; and
D7. transferring the variation set to one or more of the clients, so that the client updates the data set to the latest one according to its current data set.

17. The computer-readable medium according to claim 16, wherein the program further realizes the following functions through execution of the computer:
E7. checking whether in the server is stored the corresponding variation set requested by the client after receiving the request from the client for transmission of the corresponding variation set, and execute Step I7 if it is, or execute Step F7 if it is not;
F7. searching for the corresponding data set stored in the server that has the same mark with the current data set in the client;
G7. comparing the latest data set with the corresponding data set in Step B3 by the symbols, and obtain the variation string;
H7. transforming and marking the variation string before obtaining the corresponding variation set; and
I7. transferring the corresponding variation set to the client, so that the client updates the data set to the latest one according to its current data set and makes a mark.

18. The computer-readable medium with the computer-executable program, wherein the program further realizes the following functions through execution of the client computer:
A8. judging, when the client receives the latest variation set, whether the client has the data set to which the variation set is according, and execute Step B8 if it does, or execute Step C8 if it does not;
B8. updating the data set to the latest one and marking it according to the data set to which the variation set is according and the latest variation set;
C8. requesting the server to transfer the corresponding variation set according to the mark of the current data set in the client; and
D8. updating the data set in the client to the latest one and makes the mark after receiving the corresponding variation set by the client.
